(19) United States
(12) Patent Application Publication
(10) Pub. No.: US 2006/0092660 A1
(43) Pub. Date: May 4, 2006

(54) Backlight device and liquid crystal display apparatus of using the same

(76) Inventor: Tomohisa Tajiri, Osaka (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/251,158

(22) Filed: Oct. 14, 2005

(30) Foreign Application Priority Data
Oct. 28, 2004 (JP) JP 2004-313656

(51) Int. Cl. F21V 23/02; B64D 47/06

(52) U.S. Cl. 362/559; 362/614; 362/222; 362/260

(57) ABSTRACT

In a direct type backlight device for large-size LCD device, the shape of fluorescent tube holder must be such that following defects can be prevented or reduced, such as uneven luminance caused by the sagging and deforming of a fluorescent tube due to its own weight and longer length, the damages of the fluorescent tube caused by vibration and impact, the heat conduction from the fluorescent tube to the fluorescent tube holder leading to the temperature of the fluorescent tube being lower than surrounding temperature and the unevenness of luminance caused by degradation of luminance level around the contacting portion of the fluorescent tube. To achieve to the aforementioned purposes, the invention discloses a fluorescent tube holder having a polygon clamping shape to hold the fluorescent tube at specific position and to reduce a contacting area with the fluorescent tube for minimizing luminance unevenness caused by heat conduction.

### BACKGROUND OF THE INVENTION

a) Field of the Invention

The invention relates to a direct type backlight device for liquid crystal display apparatuses.

b) Description of the Related Art

A liquid crystal display (LCD) apparatus that is used as display apparatus for microcomputer or television does not emit light itself, and therefore, unlike self-luminescent display apparatuses like cathode ray tubes (CRT) and plasma display panels (PDP), LCD devices must have a light source such as a backlight source.

The backlight device of LCD apparatus generally uses fluorescent tubes with small tube diameter, like cold-cathode tubes or hot-cathode tubes, and can be divided into 2 types: edge light type and direct type. In the edge light type, fluorescent tubes are placed at the side of a light-guide plate such that light emits from the LCD side of the light-guide plate. In the direct type, the direct light from the fluorescent tubes and the reflected light that is the light from the fluorescent tubes reflected by a reflective plate are made incident to a transparent diffusing plate placed at an opening of a frame, such that the light is diffused into uniform planar light before being emitted.

For apparatuses requiring high luminance level, like monitors and televisions, the direct type is the more suitable one of the two backlight types due to its high efficiency of light use and its flexibility in freely changing the number of fluorescent tubes used according to required luminance level and lighting area.

Because the fluorescent tube is shorter, the direct type backlight device used in small-size LCD apparatuses mainly supports the fluorescent tube only in proximity to its two ends, or supports the whole fluorescent tube and openings are only located at the direction of light emission.

The direct type backlight device used in large-size LCD apparatuses has longer fluorescent tubes which sag and deform due to their own weight, thereby variation occurs to the distance between the diffusing plate and the fluorescent tubes and the distance between the reflective plate and the fluorescent tubes, and thus leading to uneven luminance.

Moreover, because the diameter of the fluorescent tubes is smaller than the length of the fluorescent tubes, the fluorescent tubes are easily damaged due to vibration and impact.

To prevent these situations from happening easily, the direct type backlight device of large-size LCD apparatuses often uses fluorescent tube fixation components (fluorescent tube holder) at one or two places of the fluorescent tube lengthwise.

Examples of this type of fluorescent tube holder have been disclosed in Japanese Laid-Open Patent Publication JP-H5-119703 (reference 1) and JP2001-210126 (reference 2).

The reference 1 has proposed an outer frame of a backlight device as shown in FIGS. 7A, 7B, and 7C, wherein on a frame 1 that acts as a reflective plate for reflecting light from a light source to a lighting side, tube supporters 5 for supporting a fluorescent tube 3 (the light source) at its two ends are placed, and a supporter 4 is further placed in the frame 1 to support the fluorescent tube 3 at its center section. In this structure, the fluorescent tube 3 is additionally supported at the center section, which bears the external force, and thus protecting the fluorescent tube 3 from damages.

The reference 2 has proposed a tube holder 4 as shown in FIGS. 8A, 8B, and 8C. The tube holder 4 is formed in a circular gripping shape having an opening in one part, made of a transparent material having flexibility, and integrally formed for a single tube or multiple tubes. By the tube holder 4, the fluorescent tube 3 is protected, and the positional precision of the fluorescent tube array is secured to prevent luminance unevenness of an information display panel. At the same time, effects such as poor luminance uniformity or degradation of luminance level on the information display panel due to the shade of the tube holder 4 can be prevented because the tube holder 4 is made of transparent material.

### SUMMARY OF THE INVENTION

As mentioned above, a direct type backlight device of a large-size LCD device must have a supportive fluorescent tube holder like the ones described in the reference 1 and the reference 2 to prevent the uneven luminance caused by the sagging and deforming of the fluorescent tube due to the length and weight of the fluorescent tube itself, and to protect the fluorescent tube from being damaged due to vibration and impact.

The fluorescent tube holder supports the fluorescent tube and has to be in contact therewith. The contacting portion of the fluorescent tube has a temperature that is lower than surrounding temperature due to heat conduction from the fluorescent tube to the fluorescent tube holder, and the uneven luminance occurs because of degraded luminance level around the contacting portion of the fluorescent tube. These problems are more significant when the contacting area of the fluorescent tube holder and the fluorescent tube is larger.

In view of the above, a backlight device of the invention is disclosed to have a reduced contacting area of a fluorescent tube holder and a fluorescent tube by forming a fluorescent tube supporter of the fluorescent tube holder into polygon shape to reduce the uneven luminance caused by heat conduction.

To achieve the aforementioned purposes, the present invention discloses a backlight device having a flat frame with a top plane formed with an opening, a reflective plate attached to an interior of the flat frame, a transparent diffusing plate disposed on the opening, and a plurality of fluorescent tubes on the reflective plate which are supported by a fluorescent tube holder, wherein a holding section of the fluorescent tube holder is of a polygon clamping shape.

To achieve the aforementioned purposes, the invention also discloses a backlight device having a flat frame with a top plane formed with an opening, a reflective plate attached to an interior of the flat frame, a transparent diffusing plate disposed on the opening, and a plurality of fluorescent tubes on the reflective plate which are supported by a fluorescent tube, wherein a holding section of the fluorescent tube holder is of a polygon clamping shape with a notch in one part and is made of flexible material.

To achieve the aforementioned purposes, the invention also discloses a backlight device with a plurality of fluorescent tubes placed therein, which further includes a plurality of fluorescent tube supporters and at least one integrally formed fluorescent tube holders.

By using the aforementioned fluorescent tube holder, the backlight device of the invention prevents the fluorescent tubes from sagging and deforming due to their own weight, which leads to uneven luminance, and protects the fluorescent tubes from damages caused by vibration and impact. At the same time, the shape of the fluorescent supporters is of a polygon shape with a notch, thereby reduces the contacting area of the fluorescent tube holder and the fluorescent tube and minimizes the uneven luminance caused by heat conduction.

Moreover, the backlight device with a plurality of fluorescent tubes includes a plurality of fluorescent tube supporters and at least one integrally formed fluorescent tube holder, which in turn enhances assembly work and reduces material cost.

### BRIEF DESCRIPTION OF THE DRAWINGS

FIGS. 1A, 1B, and 1C illustrate, respectively, a front view, a sectional view and a side view of a backlight device according to an embodiment of the invention.

FIG. 2 illustrates an assembly of a backlight device according to a first embodiment of the invention.

FIG. 3 illustrates an assembly of a backlight device according to a first embodiment of the invention.

FIG. 4 illustrates an assembly of a backlight device according to a second embodiment of the invention.

FIG. 5 illustrates an assembly of a backlight device according to a second embodiment of the invention.

FIG. 6 illustrates an assembly of a backlight device according to a third embodiment of the invention.

FIGS. 7A, 7B, 7C illustrate, respectively, a sectional view of a backlight device, a fluorescent tube holder, and a side view of a backlight device according to the reference 1.

FIGS. 8A, 8B, 8C illustrate, respectively, a front view, a sectional view, and a side view of a backlight device according to the reference 2.

### DETAILED DESCRIPTION OF THE INVENTION

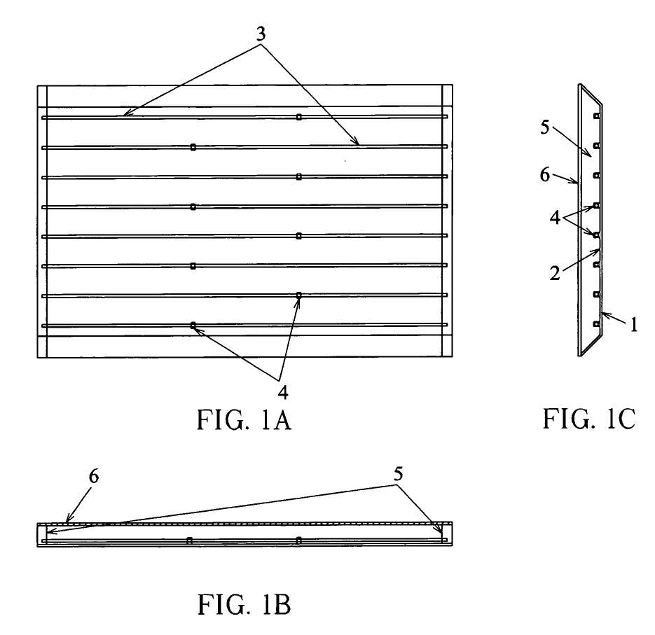

FIGS. 1A, 1B, 1C-6 are referred to for the description of a backlight device according to embodiments of the invention.

### FIRST EMBODIMENT

Referring to FIGS. 1A, 1B, 1C, 2 and 3 for the description of a backlight device according to a first embodiment of the invention, in which FIGS. 1A, 1B, and 1C illustrate, respectively, the front view, sectional view, and side view of a backlight device of the invention. As shown in FIGS. 1A, 1B, and 1C, the backlight device includes a frame 1, a reflective plate 2 attached to an interior of the flat frame, at least one fluorescent tube 3, at least one fluorescent tube holder 4, at least one fluorescent tube end supporter 5, and a (transparent) diffusing plate 6.

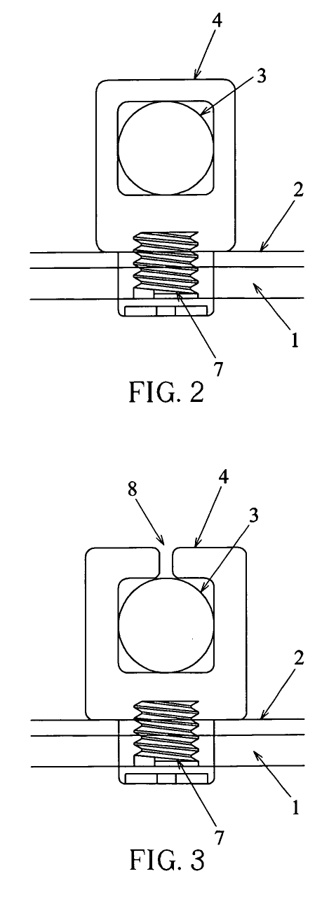

FIG. 2 illustrates the fluorescent tube holder 4, which has a holding shape for holding fluorescent tubes, being installed in the frame 1. The fluorescent tube holder 4 is secured by applying fixation elements such as screws 7 to the specific fixation holes in the frame 1 after the fluorescent tube 3 is inserted into the fluorescent tube holder 4. Since the shape of the fluorescent tube holder 4 is such that it holds the fluorescent tube 3 at several points of the circumference, the fluorescent tube 3 is more resistant to vibration and impact and the fluorescent tube holding section can be thinner.

FIG. 3 illustrates a flexible fluorescent tube holder 4 formed in a polygon clamping shape having a notch 8 in one part and secured by the screws 7 applied to the specific fixation holes of the frame 1. Since the fluorescent tube 3 can be installed by squeezing through the notch 8 of the fluorescent tube holder 4, the holding force of the fluorescent tube 3 is slightly less than that of the embodiment in FIG. 2 but processes for assembling the backlight device can be simplified.

As shown in FIGS. 2 and 3, the fluorescent tube holder 4 secured by the screws 7 is made of transparent plastic or rubber material to minimize the unevenness of luminance caused by the shade of the fluorescent tube holder 4.

### SECOND EMBODIMENT

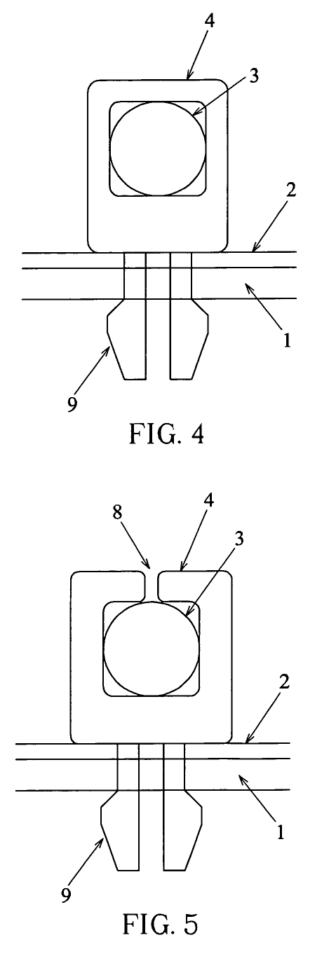

Referring to FIGS. 4 and 5, which illustrate a backlight device according to a second embodiment of the invention. In the second embodiment as shown in FIGS. 4 and 5, the fluorescent tube holder 4 is secured to the frame 1 by using a bushing 9.

When using the fixation method of FIGS. 4 and 5, because the light tends to leak out from the bushing 9 of the fluorescent tube 4 and degrades luminance level if transparent component were used, thus at least the part of the bushing 9 that connects with the reflective plate 2 of the fluorescent tube holder 4 is preferably made of plastic or rubber material with high reflectivity.

By employing the fluorescent tube holder 4, accordingly, the sagging and deforming of the fluorescent tube 3 due to its own weight leading to uneven luminance and the damage caused by vibration or impact can be prevented. At the same time, the shape of the fluorescent tube supporter is of a polygon shape, which reduces the contacting area of the fluorescent tube holder 4 and the fluorescent tube 3 and minimizes the unevenness of luminance caused by heat conduction.

### THIRD EMBODIMENT

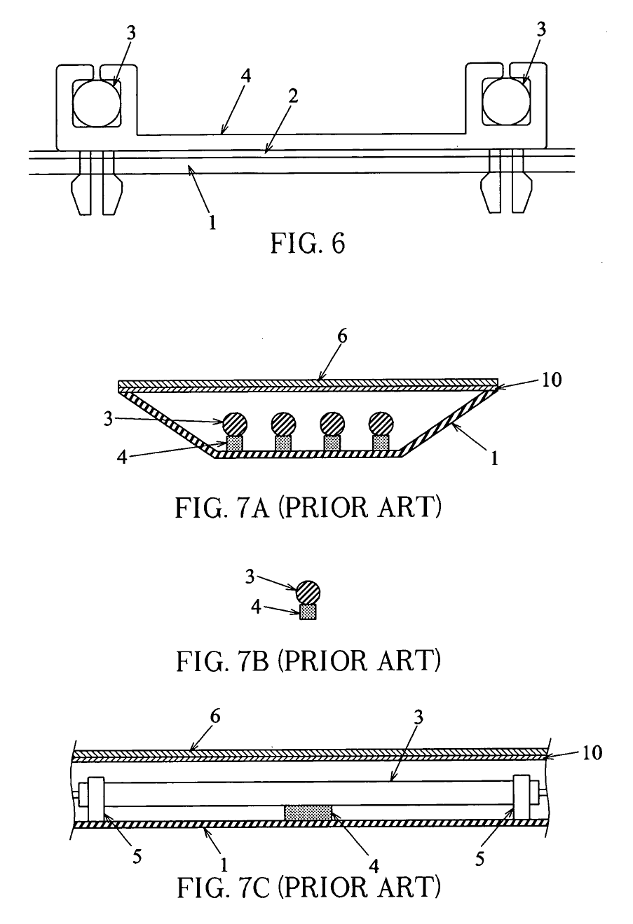

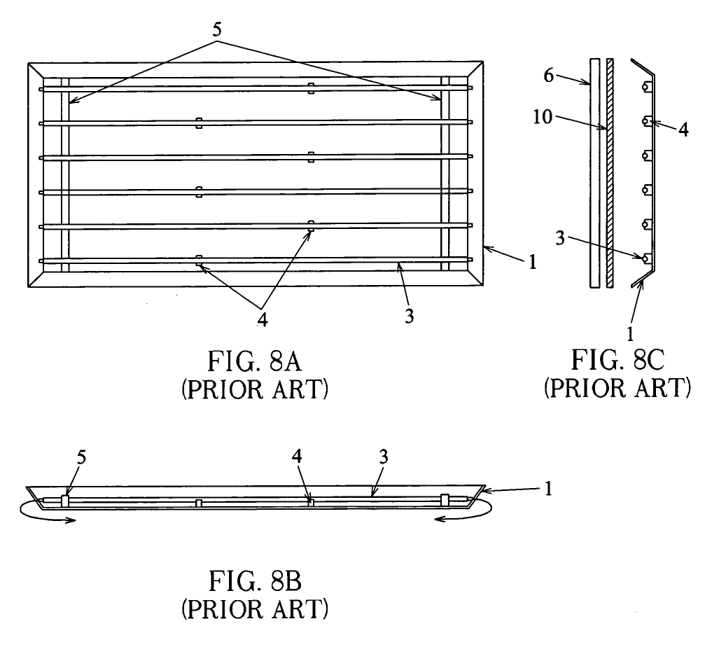

Referring to FIG. 6, which illustrates a backlight device according to a third embodiment of the invention. A fluorescent tube holder 4 for holding two fluorescent tubes is illustrated in FIG. 6. The fluorescent tube holder 4 achieves the same effect as that in the first embodiment and the second embodiment with fewer components so as to effectively reduce cost. Fluorescent tube holders for holding three or four fluorescent tubes can be used in a backlight device having more than 10 fluorescent tubes to reduce the number of components and the cost.

What is claimed is:

1. A backlight device, comprising:
a flat frame with a top plane formed with an opening;
a reflective plate attached to an interior of the flat frame;
a transparent diffusing plate disposed on the opening; and
a plurality of fluorescent tubes disposed on the reflective plate, the plurality of fluorescent tubes being supported by a fluorescent tube holder;
wherein a holding section of the fluorescent tube holder is of a polygon clamping shape.

2. The backlight device recited in claim 1, further comprising a plurality of fluorescent tube supporters and at least one integrally formed fluorescent tube holder.

3. A backlight device, comprising:
a flat frame with a top plane formed with an opening;
a reflective plate attached to an interior of the flat frame;
a transparent diffusing plate disposed on the opening; and
a plurality of fluorescent tubes disposed on the reflective plate, the fluorescent tubes being supported by a fluorescent tube holder;
wherein a holding section of the fluorescent tube holder is of a polygon clamping shape with a notch in one part and is made of flexible material.

4. The backlight device recited in claim 3, further comprising a plurality of fluorescent tube supporters and at least one integrally formed fluorescent tube holder.
